(19) United States
(12) Patent Application Publication
(10) Pub. No.: US 2022/0298619 A1
(43) Pub. Date: Sep. 22, 2022

(54) METHODS FOR PRODUCING INCREASED CRYSTALLINE AND DENSE IMPROVED COATINGS

(71) Applicant: PRAXAIR S.T. TECHNOLOGY, INC., North Haven, CT (US)

(72) Inventors: Marshall L. Sweet, Avon, IN (US); Molly M. O'Connor, Hickory Hills, IL (US)

(21) Appl. No.: 17/618,105

(22) PCT Filed: Sep. 10, 2020
(86) PCT No.: PCT/US20/50168

§ 371 Date: Dec. 10, 2021

Related U.S. Application Data
(60) Provisional application No. 62/899,871, filed on Sep. 13, 2019.

(51) Int. Cl. C23C 4/134; C23C 4/18; C23C 4/02; C23C 4/10; H05H 1/42

(52) U.S. Cl. CPC C23C 4/134; C23C 4/18; C23C 4/02; C23C 4/10; H05H 1/42

(57) ABSTRACT

Novel processes for forming improved coatings with increased crystallinity and density are provided. The process includes utilizing a laminar plasma plume to form the coatings without use of a separate auxiliary heating or post heat treatment step.

### RELATED APPLICATIONS

This application claims the benefit of International Application No. PCT/US2020/050168, filed on Sep. 10, 2020, which claimed the benefit of U.S. Provisional Application Ser. No. 62/899,871, filed on Sep. 13, 2019, which are incorporated herein by reference.

### FIELD OF THE INVENTION

This invention relates to methods for producing an increased crystalline and dense coating. More particularly, this invention relates to a novel process for utilizing a modified laminar plasma plume regime to form increased crystalline and dense coatings in an as-sprayed condition without the use of auxiliary heating or a post heat treatment.

### BACKGROUND OF THE INVENTION

The components in the hot sections of gas turbine engines are exposed to increasingly harsh operating environments. The harsh operating environments can lead to degradation and damage of the turbine engines.

To remediate such damage, coatings are often applied to the surfaces of the gas turbine engines to provide thermal, environmental, or chemical protection. Of interest is the development of coatings to protect the surfaces of ceramic matrix composite (CMC) components from oxidation and volatilization in the presence of high temperature water vapor in a turbine gas stream. For example, when silicon carbide components are exposed to elevated temperatures in the presence of water vapor, the silicon carbide decomposes by oxidation and leads to eventual volatilization of the material in the form of silicon hydroxide species.

Environmental barrier coatings (EBC's) are commonly applied to surfaces of turbine engine components to provide water vapor barriers to the underlying component. EBC's are typically applied by thermal spray processes such as air plasma spray. During a conventional air plasma spray the coating is exposed to rapid cooling rates that lead to the retention of significant amounts of amorphous or other non-equilibrium phases. These retained phases are prone to volume transformations on heating and cooling (i.e., thermal cycling) of the component that can lead to cracking of the EBC on thermal cycling. The amorphous phase has a structure characterized by a highly disordered arrangement of atoms that lacks a periodic structure or crystal lattice. Non-equilibrium phases are phases that upon thermal exposure exhibit a rearrangement of the atoms to a lower energy configuration. When the coating is deposited in the amorphous phase, subsequent thermal exposure such as that provided in service, can lead to crystallization of the amorphous phase to equilibrium and non-equilibrium structures of the material. The crystallization process involves mass rearrangement of atoms in the material that can result in the evolution of significant stresses in the coating and the production of defects, cracking, delamination, and/or eventual spallation of the protective coating layer.

To increase performance of the coating, the amorphous structure can be crystallized before being put into service. Several methods have been developed to minimize or eliminate the development of stress and defects during the crystallization process of thermally sprayed EBCs. Primary among the methods used is the application of an extensive post-deposition heat treatment that allows the coating to slowly crystallize in such a way that the stresses induced during crystallization are evolved and then thermally annealed out of the coating in a single thermal exposure. These heat treatment schedules can take in excess of 50 hours and are costly.

Another method for the development of highly crystalline coatings is the application of auxiliary heating to a component during deposition. This method includes techniques such as applying the coating by plasma spray while the component is heated inside of a high temperature furnace and resistively or inductively heating the component during the deposition process. While these methods can provide the thermal energy needed to initiate crystallization during the plasma spray process, auxiliary heating can increase the cost of the deposition process. Additionally, auxiliary heating can limit the flexibility of the process to coat a wide range of part sizes and geometries as it forms non-uniform heating that produces local overheating and melting of part regions of complex geometries.

As a result, a coating process that provides the required thermal energy for crystallization during the plasma spray process without the use of auxiliary heating or post heat treatment would be desirable. Other advantages and applications of the present invention will become apparent to one of ordinary skill in the art.

### SUMMARY OF THE INVENTION

In a first aspect of the present invention, a method of producing an improved dense and crystalline coating in an as-sprayed condition onto a substrate using a modified laminar plasma plume process, said modified laminar plasma plume process comprising the steps of: providing a cascade torch; establishing a coating process standoff distance of 3 inches or greater as measured from an outlet of the cascade torch to the substrate; generating a laminar plasma plume that contacts the substrate, wherein the laminar plasma plume is characterized as a substantially columnar shape-like structure along a longitudinal axis of the laminar plasma plume, the laminar plasma plume having a longitudinal length substantially equal to the coating process standoff distance; pre-heating the substrate with the laminar plasma plume to form a heated substrate; feeding powder particles; heating the powder particles to form molten powder particles; directing the molten powder particles from an outlet of the cascade torch into the laminar plasma plume; impinging the molten powder particles onto the heated substrate, and crystallizing the powder particles to form the improved dense and crystalline coating, said crystallizing occurring without the use of auxiliary heating or a post-heat treatment step.

In a second aspect of the present invention, a method of using a laminar plasma flow regime to create an improved dense and crystalline coating, comprising: providing a cascade torch, comprising a cathode and an anode, and one or more inner electrode inserts between the cathode and the anode to provide arc stability; establishing a predetermined coating process standoff distance as measured from an outlet of the cascade torch to a surface of the substrate; generating a laminar plasma plume that is defined, at least in part, by a longitudinal length along a longitudinal axis of the laminar plasma plume that extends from the outlet of the cascade torch to the substrate, wherein the laminar plasma plume is characterized as substantially columnar shape; pre-heating the surface of the substrate with the laminar plasma plume to a localized deposition spot temperature to form a heated substrate; introducing a powder material without substantially disrupting the laminar plasma plume; heating the powder particles to form molten powder particles; directing the molten powder particles from an outlet of the cascade torch into the laminar plasma plume and towards the heated substrate; impinging the molten powder particles onto the heated substrate, and crystallizing the powder particles to form the improved dense and crystalline coating, said crystallizing occurring without the use of auxiliary heating or a post-heat treatment step.

The invention may include any of the aspects in various combinations and embodiments to be disclosed herein.

### BRIEF DESCRIPTION OF THE DRAWINGS

The objectives and advantages of the invention will be better understood from the following detailed description of the preferred embodiments thereof in connection with the accompanying figures wherein like numbers denote same features throughout and wherein:

FIG. 1 shows a process schematic in accordance with one aspect of the present invention;

FIG. 2 shows a block flow diagram in accordance with one aspect of the present invention;

FIG. 3a illustrates a representative heat flux profile of a turbulent plasma plume;

FIG. 3b illustrates a heat enthalpy profile as a function of a radial location or FIG. 3a;

FIG. 3c show a cross-sectional view of the energy profile of the turbulent plasma plume of FIG. 3a;

FIG. 4a illustrates an exemplary heat flux profile of a laminar plasma plume in accordance with the principles of the present invention;

FIG. 4b illustrates a heat enthalpy profile as a function of a radial location for FIG. 4a;

FIG. 4c shows a cross-sectional view of the energy profile of the laminar plasma plume of FIG. 4a;

FIG. 5a shows x-ray diffraction data of amorphous phases in a coating prepared by a conventional turbulent plasma plume as shown in FIGS. 3a, 3b and 3c;

FIG. 5b shows an optical microscopy image at a magnification of 200× of the coating of FIG. 5a;

FIG. 6a shows x-ray diffraction data in a coating prepared by a laminar plasma plume as shown in FIGS. 4a, 4b and 4c; and

FIG. 6b shows an optical microscopy image at a magnification of 200× of the coating of FIG. 6a.

### DETAILED DESCRIPTION OF THE INVENTION

The objectives and advantages of the invention will be better understood from the following detailed description of the embodiments thereof in connection. The present disclosure relates to novel coating processes for producing improved coatings with increased crystallinity and density. The disclosure is set out herein in various embodiments and with reference to various aspects and features of the invention.

The relationship and functioning of the various elements of this invention are better understood by the following detailed description. The detailed description contemplates the features, aspects and embodiments in various permutations and combinations, as being within the scope of the disclosure. The disclosure may further be specified as comprising, consisting or consisting essentially of, any of such combinations and permutations of these specific features, aspects, and embodiments, or a selected one or ones thereof.

Prior to emergence of the present invention, a major challenge in the deposition of coatings by thermal spraying has been to develop a desired structure of the thermal spray coating using a process that is intrinsically non-equilibrium. In the case of materials systems such as the rare earth disilicate-based ceramics used for environmental barrier coatings, the relatively rapid cooling rates can trap the coating into undesirable metastable crystal structures including fully or partially amorphous coating structures. These resulting so-called “vitreous coatings” are then undesirably prone to crystallization to the equilibrium crystal structures upon high temperature service and eventually can lead to cracking and failure of the coating.

To overcome the above-mentioned challenges, the present invention offers a solution which is a notable departure from conventional plasma coating processes which utilize turbulent plasma plume flow regimes. In particular, the inventors have discovered that a laminar plasma plume with specific attributes as will be discussed, can be used to preheat the substrate to a sufficient temperature, followed by optimal introduction of powder particles into the in-tact laminar plasma plume without disruption of the laminar plasma plume. The particles are heated by the laminar plasma plume and accelerate towards the surface of the part or component to be coated. The term “laminar plasma plume” as used herein and throughout is intended to mean a plasma plume that is substantially isenthalpic along the radial axis of the torch, thereby leading to elimination or significant reduction of a radial gradient of the plasma parameters when compared to a traditional turbulent plasma plume. The thermal and kinetic energy supplied by the laminar plasma plume is capable of depositing a significantly dense and crystalline coating for a given application.

During this inventive process, by means of the relatively higher heat flux along the axis of the laminar plume in comparison to conventional processes, the coating and substrate are heated in a controlled manner to a temperature at or above the glass transformation temperature of the material being deposited. Creating and maintaining the glass transformation temperature is particularly important for the deposition of high-quality coatings of materials in which crystallization of the equilibrium phase has been historically suppressed by rapid cooling as is the case for rare earth disilicate and aluminosilicate environmental barrier coatings. Unlike conventional processes that utilize a turbulent plasma plume, the application of repeated directed heating of the substrate by the laminar plasma plume while the coating accumulates therealong ensures that during the deposition of each pass or layer of the thermally sprayed coating there exists the required thermal energy to cause both nucleation and growth of the crystals of the desired equilibrium phase, while limiting or eliminating the formation of amorphous phases in the coating. The use of a laminar plasma as specifically created by the present invention to possess certain characteristics reduces and/or eliminates the need for subsequent thermal processing of parts or components as a result of elimination or reduced amounts of amorphous phases or structures in the resultant coating. On the contrary, coatings produced by conventional plasma processes are significantly amorphous and undergo crystallization which occurs in service in a manner that causes the coating to damage.

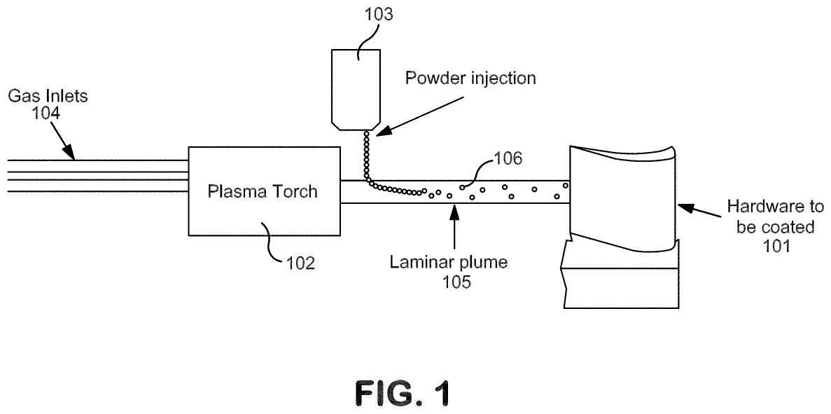

An exemplary embodiment of the present invention will be discussed with respect to FIGS. 1, 2, 4a and 4b. The present invention utilizes a laminar plasma plume regime to create improved coatings having increased crystallinity and increased density. Referring to FIG. 1, in one embodiment, a coating process 100 is used to coat a substrate 101, such as a turbine blade. The process 100 includes providing a plasma torch, preferably a cascade torch 102 as described in greater detail in U.S. Pat. Nos. 7,750,265; 9,150549; and 9,376,740 (“the Belashchenko patents”), each of which is incorporated herein by reference in its entirety for all purposes. The cascade torch 102 may include a cathode module having at least one cathode, a pilot insert module, an anode module and at least one inter-electrode insert module (IEI) to provide arc stability. A forming module may be located downstream of anode arc root for shaping and/or controlling the velocity profile of a plasma stream exiting the region of the anode arc root. For purposes of clarity, the structural details of the cascade torch 102 have been omitted in order to better illustrate the principles of using a laminar plasma plume to create improved coatings with higher crystallinity and density in accordance with the principles of the present invention. Gas inlets to the torch provide a combination of plasma process gas and carrier gasses.

A coating process standoff distance is established that is a minimum of 3 inches or greater. As used herein and throughout, the term “coating process standoff distance” is the distance measured from the outlet of the cascade torch 102 to the substrate 101 (e.g., turbine blade). In this regard, the substrate 101 to be coated is located at the approximate termination (i.e., distal end) of the laminar plasma plume 105 which is three inches or more from the outlet of the plasma torch 102.

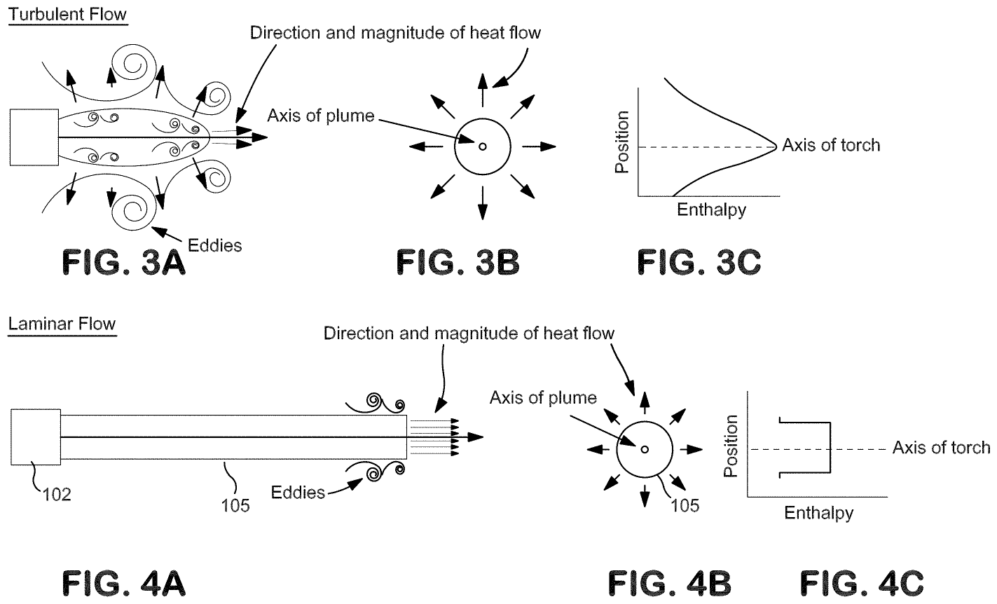

An electrical power supply (not shown) is operably connected to supply power to the cascade torch 102. A plasma gas 104 is supplied into the inlet of cascades torch 102. The plasma gas 104 is ionized within the torch 102 to produce a laminar plasma plume 105. The laminar plasma plume 105is substantially isenthalpic along the radial axis of the torch 102 (FIGS. 4a and 4b), thereby leading to elimination or a significantly smaller radial gradient of the plasma parameters when compared to a traditional turbulent plasma plume, which has a enthalpy profile that varies significantly with the radial axis of the torch 102 (FIGS. 3a and 3b). The laminar plasma plume 105 is created to specifically extends from the outlet of the torch 102 and contact the surface of the substrate 101 to be coated, thereby having a longitudinal length substantially equal to the coating process standoff distance. The process 100 minimizes or eliminates eddies and minimizes atmospheric air entrainment into the laminar plasma plume 105 in comparison to the process of FIGS. 3a and 3b. By minimizing eddies in the laminar plasma plume 105 in comparison to that of turbulent plume shown in FIGS. 3a, the enthalpy and associated heat content of the laminar plasma plume 105 can be more effectively focused towards the substrate 101, but in a manner that does not impart excessive heat onto the substrate 101 such that thermal damage occurs. The thermal energy from the laminar plasma plume 105 is transferred in a controlled manner towards the substrate 101 in a direction that is substantially parallel to the longitudinal axis of the laminar plasma plume 105.

The laminar plasma plume 105 pre-heats the substrate to a temperature that is at or above a glass transition temperature of the resultant coating to be deposited. Of particular significance and benefit is the elimination of auxiliary heating sources when pre-heating the substrate 101. By keeping the substrate 101 and the coating built-up thereon at or above the glass transition temperature, conditions favoring crystal formation of the resultant formation are established. Specifically, the powder particles 106 upon impinging the substrate 101 undergo a cooling rate that is suitable to reduce or minimize formation of amorphous phases in comparison to a coating produced by a turbulent plasma plume of FIGS. 3a and 3b.

With the substrate 101 preheated with laminar plasma plume 105, and the laminar plasma plume 105 structurally in-tact with its distal end touching the substrate 101, the powder particles can now be introduced. Hopper 103 can introduce the powder particles 106 into the laminar plume 105. One example of a configuration for introducing the powder is shown in FIG. 1. The powder particles 106 are shown to be radially injected into the laminar plasmas plume 105 at a position that is downstream of the torch 102. Carrier gas is introduced at the gas inlet to the plasma torch 102. The introduction of powder particles 106 occurs at carrier gas flow rates and at an injection angle that does not disrupt the laminar plasma plume 105. The carrier gas entrains the powder particles 106 within the laminar plume 105 as shown in FIG. 1 and the entrainment is also without disruption of the laminar plasma plume 105. Although radial injection is shown, it should be understood that other injection configurations are contemplated, including, by way of example an axial injection of powder particles 106 with a suitable inert carrier gas.

The powder particles 106 are heated within the laminar plasma plume 105 such that substantially all of the particles 106 become molten. The powder particles 106 in such molten state are accelerated towards the substrate 101. The power particles impinge the substrate 101 and crystallize to form a resultant coating with increased crystallinity and density. The integrity of the laminar plasma plume 105 is maintained during the formation of the coating. Additionally, the laminar plasma plume 105 remains in contact with the substrate 101 to ensure that the coating accumulating onto the substrate 101 is sufficiently heated and maintained at a temperature at or above the glass transition temperature of the resultant coating. The resultant coating possesses sufficient crystallinity such that no post-heat treatment or auxiliary heating is required.

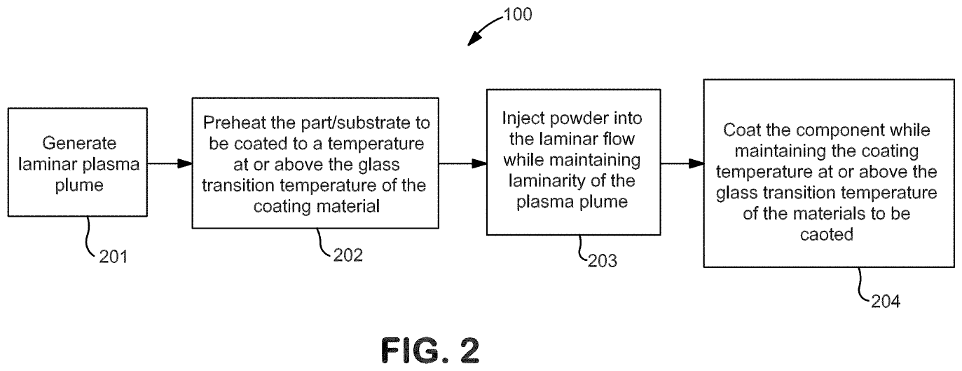

A high level block flow diagram representative of the key steps of the of the present invention in one aspect and as described hereinabove with respect to process 100 is shown in FIG. 2. Process 100 requires generating a laminar plasma plume (step 201); preheating the part/substrate to be coated to a temperature at or above the glass transition temperature of the coating material (step 202); injection of powder into the laminar plasma plume 105 while maintaining the laminarity of the plasma plume 105 (step 203); and coating the part/substrate while maintaining the coating temperature at or above the glass transition temperature of the coating materials (step 204).

Various improved coatings with increased crystallinity and density can be produced using the techniques of the present invention. For example, in another embodiment of the present invention, it has been found that by using a high enthalpy plasma torch in a laminar flow regime at relatively long standoff distances in comparison to conventional turbulent plasma flow processes (FIGS. 3a and 3b), it is possible to deposit coatings of rare earth disilicates with significantly high levels of high temperature stable crystalline phases present without the use of auxiliary heating or post deposition heat treatments. The method for such deposition involves utilizing the methodology of the present invention, namely: (i) operating a plasma cascade torch with a series of inner electrode inserts such that it operates in the laminar flow regime within which a laminar plasma plume is created; (ii) preheating the substrate using the laminar plasma plume; (iii) entraining the powder feedstock in the laminar plasma plume to heat the powder particles above its melting temperature without disruption of the laminar plasma plume; (iv) accelerating the powder particles towards the surface of the substrate; and (v) impinging the particles onto the surface of the substrate while the laminar plasma plume remains in contact with the surface of the substrate and is concurrently heating the substrate such that the impacted molten particles cool at a rate to reduce, eliminate or minimize formation of amorphous phases relative to conventional processes so that vitrification (e.g., formation of non-crystalline, amorphous materials) is predominantly suppressed.

The laminar plasma plume 105 as utilized by the present invention is created with specific power and thermal heat transfer characteristics favorable for creating the improved coatings, as will now be described with respect to FIGS. 4a and 4b. FIG. 4a shows that the laminar plasma plume 105 does not entrap eddies which leads to a significantly longer plasma plume 105 with predominately unidirectional heat flow along the axis of the plasma plume. The plume 105 can then be positioned such that the part 101 to be coated is at or near the distal end of the laminar plasma plume 105 leading to significant heat transfer to the part 101 during deposition.

The laminar plasma plume 105 is defined, at least in part, by a longitudinal length along a longitudinal axis of the laminar plasma plume 105 that extends from the outlet of the cascade torch 102 to the substrate 101. The longitudinal length remains substantially constant during the process 100 and is substantially equal to the standoff distance, which is 3 inches at minimum or greater. The laminar plasma plume 105 can be further characterized as columnar-like in structure as can be seen in FIG. 4a. The columnar-like structure allows the enthalpy profile (FIG. 4b) and associated heat content (FIG. 4a) to remain constant and distributed uniformly and along the radial direction of the torch 102. The enthalpy and heat content associated with the laminar plasma plume 105 is not localized in front of the torch 102. Additionally, a cross-section of the laminar plasma plume 105 in FIG. 4c indicates that the magnitude of heat losses radially outwardly is smaller in comparison to that of the turbulent plasma plume show in cross-section in FIG. 3c.

On the contrary, referring to FIGS. 3a, 3b and 3c, strong eddies are shown around and within the turbulent plasma plume, which truncates the plasma plume and leads to significant shorter observed plumes and dramatically increased heat transfer radially out from the axis of the plume. This is show in the cross-sectional view of the plasma plume and position verses enthalpy curves, both of which show removal of energy and heat from the plasma plume in the radial direction.

The characteristics of the laminar plasma plume 105 as created by the present invention collectively contribute to form a localized deposition spot temperature of the heated substrate 101 that is greater than a corresponding localized deposition spot temperature created by a conventional plasma turbulent plasma plume of FIGS. 3a and 3b, thereby allowing formation of increased crystalline and densified coatings. The use of a laminar plasma plume 105 to develop highly crystalline coatings is based on the ability of the laminar plasma plume 105 to create a columnated plasma with a predominantly oriented unidirectional heat flux that preferentially directs heat flow in a controlled manner from the plasma along the axis of the torch. This concentration of thermal energy can then be directed at the part to be coated.

While the preferred embodiments of the process have been set forth above, the following examples are intended to provide a basis for comparison of the present invention, with other coating processes, but they are not to be construed as limiting the invention. X-ray diffraction and optical microscopy images of as-sprayed coating cross sections deposited by the present invention were performed and compared to the same for coatings produced by conventional state of the art technology as described in the Examples below.

### COMPARATIVE EXAMPLE 1

### (Turbulent Plasma Plume Conventional Process)

A conventional turbulent plasma plume as shown in FIGS. 3a, 3b and 3c was utilized to produce a rare earth disilicate (RE2Si2O7) coating. A turbulent plasma plume was created using a F4 plasma torch (commercially available from Metco) at typical operating parameters. A coating process standoff distance of 4 inches was created. The torch was used to pre-heat the substrate before the coating was applied. The turbulent plasma plume was non-isenthalpic and not stable. The plume was relatively short (in comparison to that of Example 1) and triangularly-shaped. The turbulent plasma plume did not contact the substrate surface during the coating. It was determined that the turbulent plasma plume exhibited turbulent eddies.

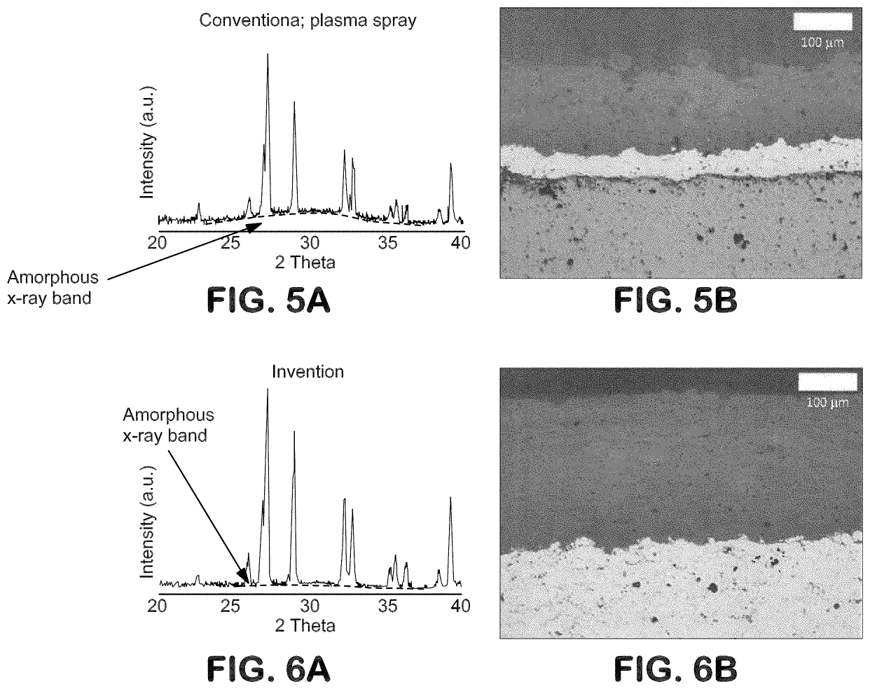

X-ray diffraction data was obtained on the coating and the results reported in FIG. 5a. The x-ray diffraction data indicated significant x-ay band characteristics indicative of non-crystalline material present in the coating. The results indicated unacceptably high levels of amorphous phases that required subsequent post heat treatment or auxiliary heating.

The optical microscopy images at a magnification 200X of the coating was obtained and is shown at FIG. 5b. The optical microscope image exhibited the presence of unacceptably high amounts of unmelted particles and porosity, both of which are detrimental to the effectiveness of the coating.

### EXAMPLE 1

### Laminar Plasma Plume Invention

A laminar plasma plume process as shown in FIGS. 4a, 4b and 4c was utilized to produce a rare earth disilicate (Re2Si2O7) coating in the as-sprayed condition. A coating process standoff distance of more than 3 inches was created. A laminar plasma plume was created using a cascade torch. The laminar plasma plume had a columnar-like structure as shown in FIG. 4a. The plume had a longitudinal length longer that of the turbulent plasma plume. The temperature of the substrate was pre-heated to a temperature at or above the glass transition temperature of the coating. The plume was isenthalpic. The stability of the laminar plasma plume was observed to be maintained throughout the coating process. The presence of eddies was not detected.

X-ray diffraction data was obtained on the coating and the results reported in FIG. 6a. The x-ray diffraction data indicated predominately distinct and narrow full width half maximum crystalline peaks that identify the C-type rare earth disilicate crystal structure. The x-ray diffraction data in FIG. 6a indicated a significantly lower magnitude of the amorphous x-ray band within the coating in comparison to that produced by the turbulent plasma plume of Comparative Example 1. This diffraction data was indicative of a notable decrease in the amount of amorphous phase in the coating. It was therefore concluded that the coating had higher crystallinity than that produced in Comparative Example 1. The coating did not require subsequent auxiliary heating or a post heat treatment step.

The optical microscopy images at a magnification of 200X of the coating was obtained and is shown at FIG. 6b. The micrograph of the coating cross-section indicated a denser coating in comparison to that of Comparative Example 1. It was visually observed to be free of unmelted particles. Cracking and interconnected porosity in the coating were observed to be minimal.

While it has been shown and described what is considered to be certain embodiments of the invention, it will, of course, be understood that various modifications and changes in form or detail can readily be made without departing from the spirit and scope of the invention. It is, therefore, intended that this invention is not limited to the exact form and detail herein shown and described, nor to anything less than the whole of the invention herein disclosed and hereinafter claimed.

1. A method of producing an improved dense and crystalline coating in an as-sprayed condition onto a substrate using a modified laminar plasma plume process, said modified laminar plasma plume process comprising the steps of:
providing a cascade torch;
establishing a coating process standoff distance of 3 inches or greater as measured from an outlet of the cascade torch to the substrate;
generating a laminar plasma plume that contacts the substrate, wherein the laminar plasma plume is characterized as a substantially columnar shape-like structure along a longitudinal axis of the laminar plasma plume, the laminar plasma plume having a longitudinal length substantially equal to the coating process standoff distance;
pre-heating the substrate with the laminar plasma plume to form a heated substrate;
feeding powder particles;
heating the powder particles to form molten powder particles;
directing the molten powder particles from an outlet of the cascade torch into the laminar plasma plume;
impinging the molten powder particles onto the heated substrate, and
crystallizing the powder particles to form the improved dense and crystalline coating, said crystallizing occurring without the use of auxiliary heating or a post-heat treatment step.

2. The method of claim 1, further comprising the step of transferring thermal energy in the laminar plasma plume towards the heated substrate.

3. The method of claim 1, further comprising minimizing radial heat losses from the laminar plasma plume.

4. The method of claim 1, wherein the method of pre-heating the substrate to a temperature that is at or above a glass transition temperature of the coating.

5. The method of claim 1, wherein the improved dense and crystalline coating in the as-sprayed condition has a crystallinity that is higher than a corresponding coating produced by a turbulent plasma plume as measured by x-ray diffraction.

6. The method of claim 1, wherein the molten powder particles upon impinging the heated substrate undergoes cooling at a cooling rate that is lower in comparison to a coating prepared by a conventional turbulent plasma plume process.

7. The method of claim 1, wherein the step of introducing powder particles occurs without substantial disruption of the laminar plasma plume.

8. The method of claim 1, further comprising maintaining stability of the substantially columnar shape-like structure of the laminar plasma plume.

9. The method of claim 1, wherein the improved dense and crystalline coating in the as-sprayed condition has a density that is higher than a corresponding coating produced by a turbulent plasma plume as visually observed by optical microscopy at a magnification of 200-500 ×.

10. A method of using a laminar plasma flow regime to create an improved dense and crystalline coating, comprising:
providing a cascade torch, comprising a cathode and an anode, and one or more inner electrode inserts between the cathode and the anode to provide arc stability;
establishing a predetermined coating process standoff distance as measured from an outlet of the cascade torch to a surface of the substrate;
generating a laminar plasma plume that is defined, at least in part, by a longitudinal length along a longitudinal axis of the laminar plasma plume that extends from the outlet of the cascade torch to the substrate, wherein the laminar plasma plume is characterized as substantially columnar shape;
pre-heating the surface of the substrate with the laminar plasma plume to a localized deposition spot temperature to form a heated substrate;
introducing a powder material without substantially disrupting the laminar plasma plume;
heating the powder particles to form molten powder particles;
directing the molten powder particles from an outlet of the cascade torch into the laminar plasma plume and towards the heated substrate;
impinging the molten powder particles onto the heated substrate, and
crystallizing the powder particles to form the improved dense and crystalline coating, said crystallizing occurring without the use of auxiliary heating or a post-heat treatment step.

11. The method of claim 10, further comprising cooling the coating at a cooling rate sufficient to reduce or minimize formation of amorphous phases in comparison to a corresponding coating produced by a turbulent plasma plume.

12. The method of claim 10, wherein the predetermined coating process standoff distance is 3 inches or more.

13. The method of claim 10, further comprising creating and maintaining the longitudinal length of the laminar plasma plume to be substantially equal to the predetermined coating process standoff distance.

14. The method of claim 10, further comprising operating the cascade torch to minimize heat losses from the laminar plasma plume in a radial direction of the laminar plasma plume.

15. The method of claim 10, further introducing the powder particles directly into the laminar plasma plume.

16. The method of claim 10, further comprising minimizing atmospheric air entrainment into the laminar plasma plume.

17. The method of claim 10, further wherein the localized deposition spot temperature of the substrate is at or above a glass transition temperature of the coating.

18. The method of claim 10, further comprising maintaining substantial uniformity of the laminar plasma plume along the radial direction of the laminar plasma plume.

19. The method of claim 10, further comprising transferring thermal energy from the laminar plasma plume to the substrate in a direction that is substantially parallel to the longitudinal axis of the laminar plasma plume.

20. The method of claim 10, further comprising maintaining contact of the laminar plasma plume with the substrate during formation of the improved dense and crystalline coating.

21. The method of claim 10, wherein the localized deposition spot temperature to form the heated substrate is greater than a corresponding localized deposition spot temperature created by a turbulent plasma plume.
